(19) United States
(12) Patent Application Publication
(10) Pub. No.: US 2014/0251699 A1
(43) Pub. Date: Sep. 11, 2014

(54) FLUID WEIGHT DETECTION DEVICE

(71) Applicant: Carl Bright, Harrah, OK (US)

(72) Inventor: Carl Bright, Harrah, OK (US)

(21) Appl. No.: 14/018,964

(22) Filed: Sep. 5, 2013

Related U.S. Application Data
(60) Provisional application No. 61/772,628, filed on Mar. 5, 2013.

(51) Int. Cl. G01G 5/04

(52) U.S. Cl. CPC G01G 5/04
USPC 177/1; 177/208

(57) ABSTRACT

A device and associated method of use may each generally be directed to a device capable of continually measuring the weight of various fluids in real-time by having at least a pneumatic bladder positioned within an enclosure and contacting a fluid. The pneumatic bladder may be connected to a sensing device that can act to measure a weight of the fluid.

### CROSS-REFERENCE TO RELATED APPLICATIONS

This application claims benefit under 35 U.S.C. 119(e) of U.S. Provisional Application Ser. No. 61/772,628, which was filed Mar. 5, 2013, which is hereby expressly incorporated herein by reference in its entirety.

### SUMMARY

Embodiments of the present disclosure may generally be directed to a device capable of continually measuring the weight of various fluids in real-time. Assorted embodiments configure a device to have at least a pneumatic bladder positioned within an enclosure and contacting a fluid. The pneumatic bladder may be connected to a sensing device that can act to measure a weight of the fluid.

### BRIEF DESCRIPTION OF THE DRAWINGS

FIG. 1 generally provides of a block representation of an example fluid weight detection system in which a fluid weight detection device can be practiced.

FIGS. 2A-2C respectively display bloc k representations of an example fluid weight detection environment capable of utilizing a fluid weight detection device in some embodiments.

FIG. 3 illustrates a block representation of an example fluid weight detection system constructed and operated in accordance with various embodiments.

FIG. 4 shows a block representation of an example fluid weight detection measuring tool configured in accordance with some embodiments.

FIG. 5 is a block representation of an example fluid weight detection measuring tool operated in accordance with assorted embodiments.

FIG. 6 displays a block representation of an example fluid weight detection measuring tool constructed and operated in accordance with some embodiments.

FIGS. 7A and 7B respectively illustrate perspective view block representations of portions of an example fluid weight detection device constructed in accordance with various embodiments.

FIG. 8 maps an example fluid measurement routine carried out in accordance with various embodiments.

### DETAILED DESCRIPTION

As hydrocarbon exploration advances, more sophisticated operating and measuring tools allow greater yields with increased safety. With drilling operations for crude oil and natural gas, drilling conditions can be volatile and few measurement tools can provide real-time response to such dynamic conditions. For example, drilling fluid, such as drilling mud, can be used to balance and control geological formations as well as to conduct well completion operations like cementing well bore casing, but can be susceptible to inadvertent weight, viscosity, and density variations that can jeopardize the completion and operation of a hydrocarbon drilling well. Hence, measurement tools that can provide real-time, on-site sensing of dynamic, harsh conditions like drilling fluid weight is a continued goal of the hydrocarbon exploration industry.

With continued emphasis on real-time measurement tools, various embodiments provide at least a pneumatic bladder positioned within an enclosure and contacting a fluid with the pneumatic bladder connected to a sensing device that can act to measure a weight of the fluid. The ability to output fluid weight in real-time is complemented by the ability to measure fluid conditions in a variety of different locations in and around a wellbore. Such measurements can then be transmitted across a network to capture drilling operation performance and conditions with increased response time, which can optimize drilling safety and precision. The use of a pneumatic bladder to measure fluid weight allows submerged surface measurement capabilities that can further heighten drilling performance in a variety of diverse drilling environments.

Generally, drilling operations measure drilling fluids in pounds per gallon (lbm/gal)/(ppg), pound per cubic feet (lb/ft³), and grams per milliliter (b/ml) with a mechanical fluid balance. The presence of air, vibration, and contaminated testing equipment can correspond to inaccurate measurements. Despite the use of a mechanical pressurized fluid balance that can reduce the presence of air in a sample, the harsh environment of drilling sites and drilling fluid can be compounded by sporadic testing conditions, such as weekly, daily, or hourly measurement under varying temperature, humidity, and weather conditions. Further these mechanical testing devices may often accompany an inability to transmit data over a network and also produce erratic and inaccurate fluid measurements that may lead to degraded drilling operations. Such erratic drilling fluid weight measurements can jeopardize wellbore stability and lead to a drilling string blow-out if the fluid weight is too light or to a contaminated hydrocarbon formation if the fluid weight is too heavy and the hydrostatic pressure causes the geological formation to fracture.

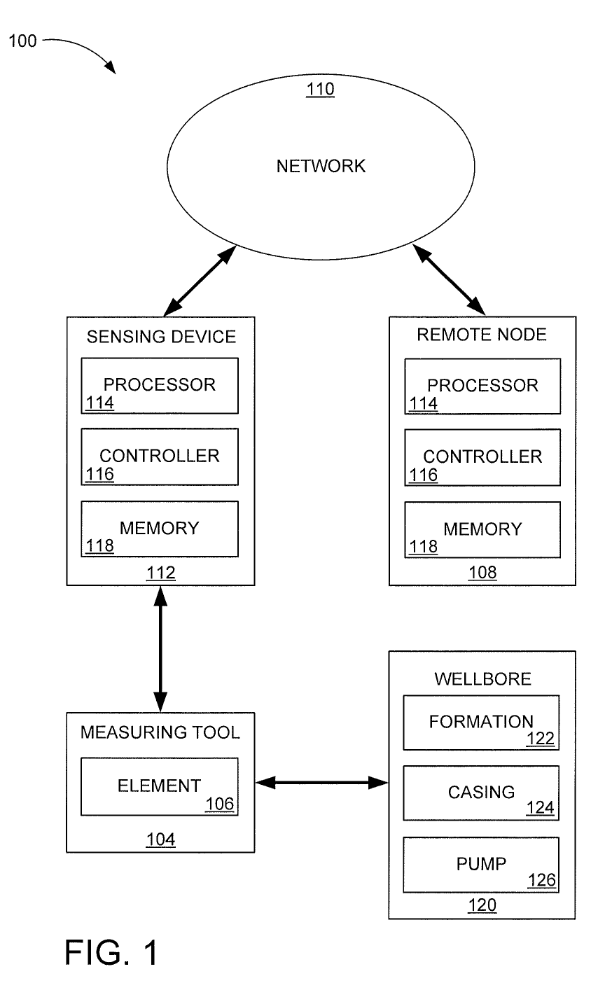

An optimized real-time drilling fluid measuring device can be utilized as part of an unlimited variety of drilling and computing systems, FIG. 1 provides an exemplary drilling system 100 configured and operated in accordance with various embodiments. The system 100 has a wellbore 120 that is engaged by a measuring tool 104 to continually, routinely, and sporadically sense one or more drilling parameters, such as pressure, fluid composition, fluid temperature, and fluid flow, with at least one measuring element 106. Such drilling parameters can be identified, analyzed, and subsequently transmitted to a remote node 108 over a network 110 by a sensing device 112 with appropriate protocol. The remote node 108 and sensing device 112 may, in various embodiments, be configured with at least one processor 114, controller 116, and memory 118 that can provide computing capabilities individually and collectively.

The transmission of measurement data over the network 110 can allow the remote node 108 to process the data to identify performance trends, errors, and areas of improvement for drilling operation quality and safety. Such transmission in conjunction with the on-site analysis of real-time measurements by the sensing device 112 can proactively identify future drilling operation errors and failures that could degrade production from the wellbore 120 by affecting the formation 122, casing 124, and pump 126 either individually or concurrently. The wellbore 120 production may further be optimized by replacing by-hand measurement of drilling fluid, which can provide sporadic analysis of drilling parameters, such as drilling mud weight, even under ideal conditions. For example, the harsh conditions present at drilling sites can quickly render traditional by-hand and remote measurement tools for drilling fluids, like piezeo pressure transducers and oscillating tuning forks, inefficient and inaccurate.

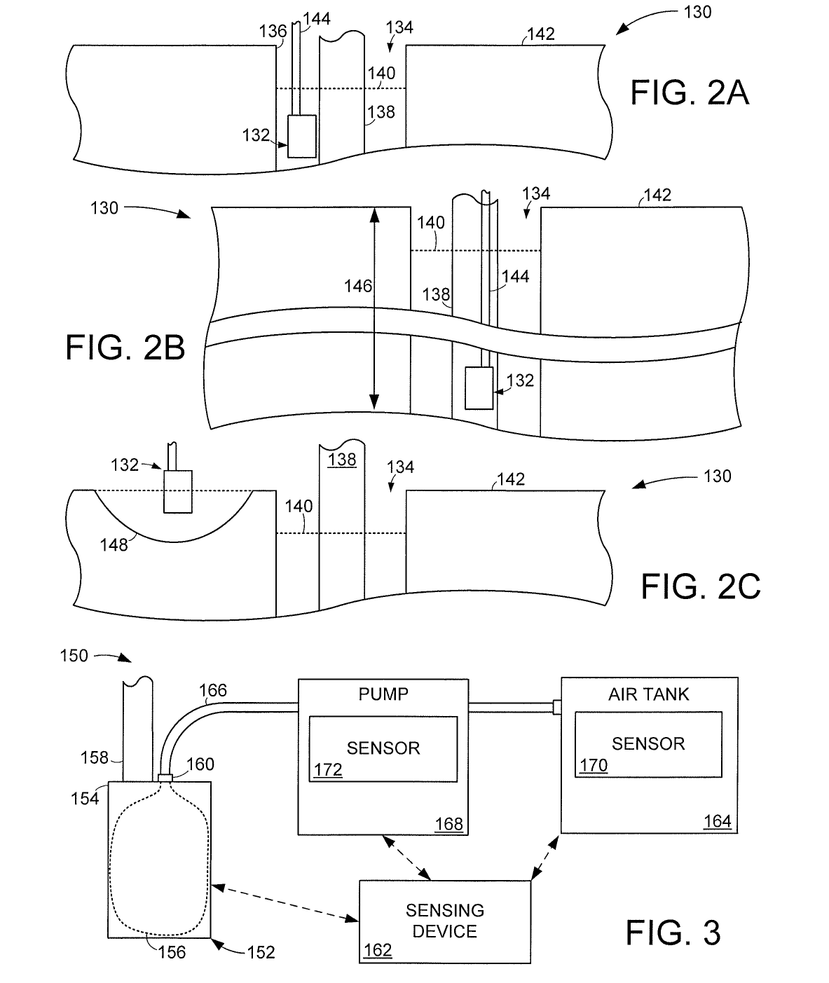

With these difficulties in mind, a measurement tool may be constructed with robust materials and efficient design to allow accurate measurement of harsh environmental conditions while maintaining high sensitivity. FIGS. 2A-2C respectively provide block representations of an example fluid measurement environment 130 in which a fluid weight detection tool 132 can be utilized in accordance with assorted embodiments.

FIG. 2A illustrates how the fluid weight detection tool 132 can be positioned within a wellbore 134 a predetermined depth and between a wellbore sidewall 136 and drilling piping 138, such as casing and rotating drilling pipe, to conduct snapshot and continual measurement of drilling fluid 140. As shown in FIG. 2A, the fluid weight detection tool 132 can measure drilling fluid in close proximity to a ground surface 142, which allows the handle 144 of the tool 132 to extend above the ground surface 142 and be positioned, moved, removed, and maintained without stopping drilling operations or displacing the drilling piping 138.

While the fluid weight detection tool 132 can be positioned to nearly any depth within the wellbore 134 between the wellbore sidewall 136 and drilling piping 138, FIG. 2B displays how the tool 132 can also be positioned within the drilling piping 138. The ability to extend the handle 144 of the tool 132 to accommodate a variety of different depths 146 allows the measurement of fluid 140 at locations of interest for the production of the wellbore 134, such as specific geological formations, drilling piping 138 joints, and horizontal drilling knuckles, without limitation. The submersion of the entire fluid weight detection tool 132 in the wellbore 134 and drilling fluid 140 can provide nearly immediate fluid conditions in real-time. The position of the tool 132 downhole can further measure drilling fluids 140 that may be too light to reach the ground surface 142 or otherwise not be accurately measured proximal the ground surface 142.

While the position of a fluid weight detection tool 132 downhole can provide fluid measurements conducive to the optimization of some drilling operations, such a downhole position is not required or limiting as the tool 132 can be utilized to measure fluid conditions with an inch or less of fluid submersion. FIG. 2C illustrates how a fluid weight detection tool 132 can be positioned outside the wellbore 134 and partially submerged in a fluid retaining structure 148, such as a mud pit, to sense at least the weight of the fluid coming in contact with the tool 132. The ability to utilize the fluid weight detection tool 132 both inside and outside the wellbore 134 can allow for dynamic testing, quality assurance, and safety checks to be conducted either with one tool 132 being repositioned or multiple tools measuring fluid from different locations in the fluid measurement environment 130 concurrently, routinely, and sporadically.

It is contemplated that a range of differently shaped enclosures and pneumatic bladder control systems can be used to detect drilling fluid weight nearly instantaneously and in real-time regardless of the position of the bladder, and corresponding fluid weight detection tool, inside or outside a wellbore. FIG. 3 is a block representation of an example fluid weight detection system 150 configured and operated in accordance with various embodiments. A fluid weight detection tool 152 has a rigid enclosure 154 that houses an inflatable bladder 156 that can be any variety of materials like rubber, polymer, and plastics that respond to encountered fluid. The enclosure 154 can have at least one rigid or flexible handle 158 that can be positioned adjacent a pneumatic coupling 160 that seals one portion of the enclosure 152 while the opposite portion is left open to let fluid contact the bladder 154.

Any number of sensors, such as proximity and pressure sensors, can be placed in and around the enclosure 154 to detect and log the effect of encountered fluid on the bladder 156. For instance, multiple sensors can concurrently detect the pressure inside and exterior shape of the bladder 156 before storing the data locally, such as in a local non-volatile memory, or sending the data to a sensing device 162 through a wired or wireless network. Even though the fluid weight detection tool 152 may be configured to sense fluid conditions alone, assorted embodiments connect the tool 152 to an external air tank 164 via at least one sealed line 166. The air tank 164 can allow a differential pressure to be established and measured by inflating and deflating the bladder 156 with at least one pump 168 while recording the change in pressure within the air tank 164 with at least one sensor 170.

Through the wired or wireless connection of the pump 168, air tank 164, and tool 152 to the sensing device 162, air can be moved between the bladder 156 and rigid air tank 164, pressure can be measured by sensors 170 and 172, and the sensing device 162 can adapt to changing environmental conditions to provide the most accurate real-time fluid weight measurements possible. That is, the sensing device 162 can monitor a number of different variables, such as humidity, air tank 164 temperature, drilling operation, drilling fluid flow rate, and bladder 156 inflation percentage, and adapt sensed data from the respective system 150 components to correct for any predictable or random sources of error that can jeopardize the integrity of a fluid weight measurement outputted by the sensing device to a host.

Although a fluid weight detection tool can be configured in an unlimited variety of manners that allow fluid to engage and exert pressure on a pneumatic bladder, FIG. 4 displays an example fluid weight detection tool 180 constructed and operated in accordance with some embodiments to provide precise real-time measurement of drilling parameters regardless of the harshness of the drilling environment. These real-time measuring devices can come in contact with harsh conditions like acidic or base chemical conditions, hydrocarbon based solvents, and high temperature drilling fluids. As such, an embodiment may be configured with a ruggedized rubber bladder 182 that allows for dynamic and controlled articulation of the bladder 182 in response to fluid conditions with degrading measurement latency and accuracy.

The use of the ruggedized bladder 182 alone may not provide accurate fluid weight measurements as the bladder 182 would float and move along with any fluids. As such, the bladder 182 can be positioned within an enclosure 184 in some embodiments so that inflation and deflation of the bladder 182 can be restricted to a predetermined housing cavity 186 and differential pressure can be measured as the bladder 182 and fluid are cooperatively contained within the cavity 186. As shown, the enclosure 184 has a single inlet/outlet 188 opposite a sealed end 190 that allows the bladder 182 to contact and respond to the weight and pressure of fluid in the cavity 186. While not required or limited, various embodiments configure the bladder 182 to be wholly pneumatic and sealed so that compressed air at a pressure greater than ambient air is selectively moved into and out of the bladder 182 to change the volume and pressure of the housing cavity 186 and allow the measurement of differential pressure that can be analyzed against a predetermined standard to render a fluid parameter, like fluid weight and density.

The shape, size, and material of the enclosure 184 and bladder 182 may be tuned an optimized for the particular wellbore, fluid conditions, and hydrocarbon formation being explored. For example, a natural gas exploration with high temperatures and pressures can be accurately measured with a stainless steel, aluminum, and high carbon steel enclosure 184 material that is cylindrically shaped with the sealed end 190 opposite the open inlet/outlet 188. Pneumatic control can be facilitated for the bladder 182 via a coupling 192 through the closed housing end 190 of the housing with a continuous pneumatic line 194 connecting the coupling 192 and bladder 182 to an external sensing device. Such a cylindrical enclosure 184 can also allow multiple different measurement locations due at least to the ability to create a differential pressure environment through controlled inflation and deflation of the bladder 182 while the enclosure 184 is secured in place by a fixed housing rod 196.

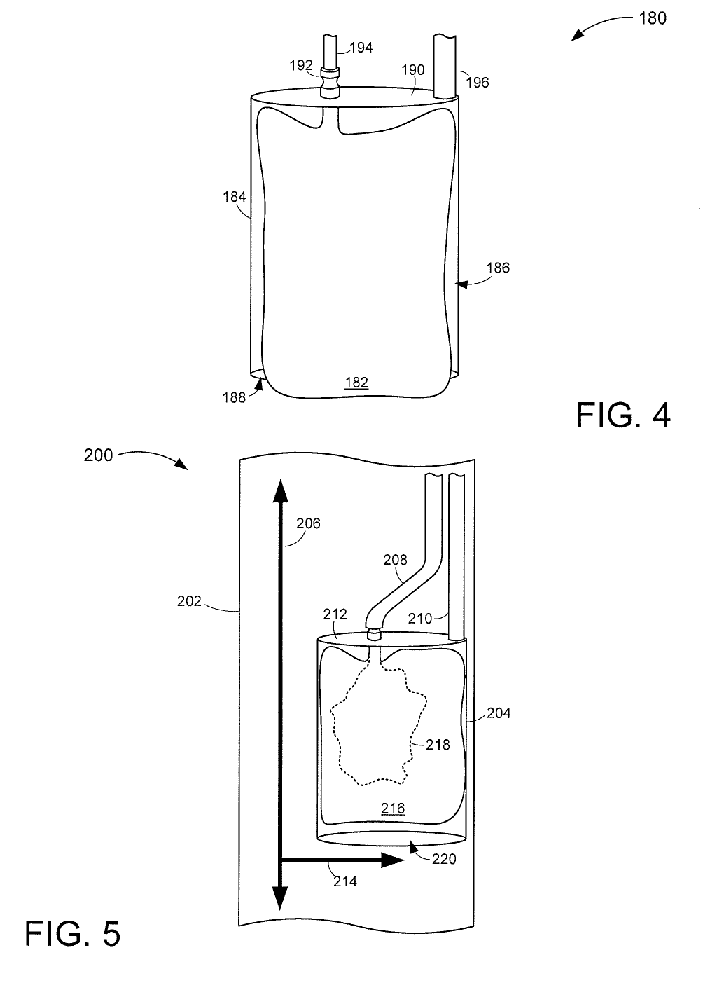

FIG. 5 generally illustrates another example fluid weight detection tool 200 operated in a submerged environment 202 in accordance with some embodiments to continually measure drilling parameters while providing real-time measurement data. The position and configuration of the housing 204 compared to the submerged environment 202 can be tuned to allow the bidirectional flow 206 of fluids including, but not limited to, air, drilling mud, hydrocarbons, natural gas, and hydraulic fluid around the housing 204. The pneumatic line 208 and housing rod 210 extending from the closed end 212 of the housing 204 each are tuned to not inhibit the bidirectional flow 206 or create drag. The size, such as less than the submerged environment 202 diameter, shape, such as cylindrical, spherical, and triangular, as well as depth, such as greater than 100 feet below the surface, can individually or collectively be tuned so that fluid may laterally flow 214 in a direction perpendicular to the bidirectional flow 206 and come into contact with the pneumatic bladder 216.

The ability to position the bladder 216 at a predetermined depth in the submerged environment 202 can allow the bidirectional 206 and lateral 214 fluid flows to stabilize under the columnar weight and pressure of fluid above the predetermined depth, which can provide the pneumatic bladder 216 to read differential pressure exerted by the fluid quickly consistently, and accurately. As a non-limiting example, the bladder 216 can be deflated, as shown by segmented line 218, and inflated to contact the sidewalls and closed end 212 of the housing 204 to provide a stable surface which the bladder 166 can push off of and establish pressure exerted from the fluid, which can immediately be sense and translated to a fluid parameter like weight by an external sensing device connected to the bladder 216 via the pneumatic line 208.

The ability to tune the materials and shape of the housing 204 for submerged environment fluid measurement can be afforded by the sensitivity of the pneumatic bladder 216 and the single inlet/outlet 220 that allows fluid to exert pressure on the bladder 216 and consequently the closed end 212 and sidewalls of the housing 204. Inflation and deflation of the bladder 216 can further be used to create a differential pressure and draw fluid into the inlet/outlet 220 for contact with the bladder 216 and parameter measurement. Such bladder 216 articulation can therefore aid in lateral fluid flow 214 to minimize the presence of any anomalies, such as debris and air, from the measured fluid sample in contact with the bladder 216 within the housing 204.

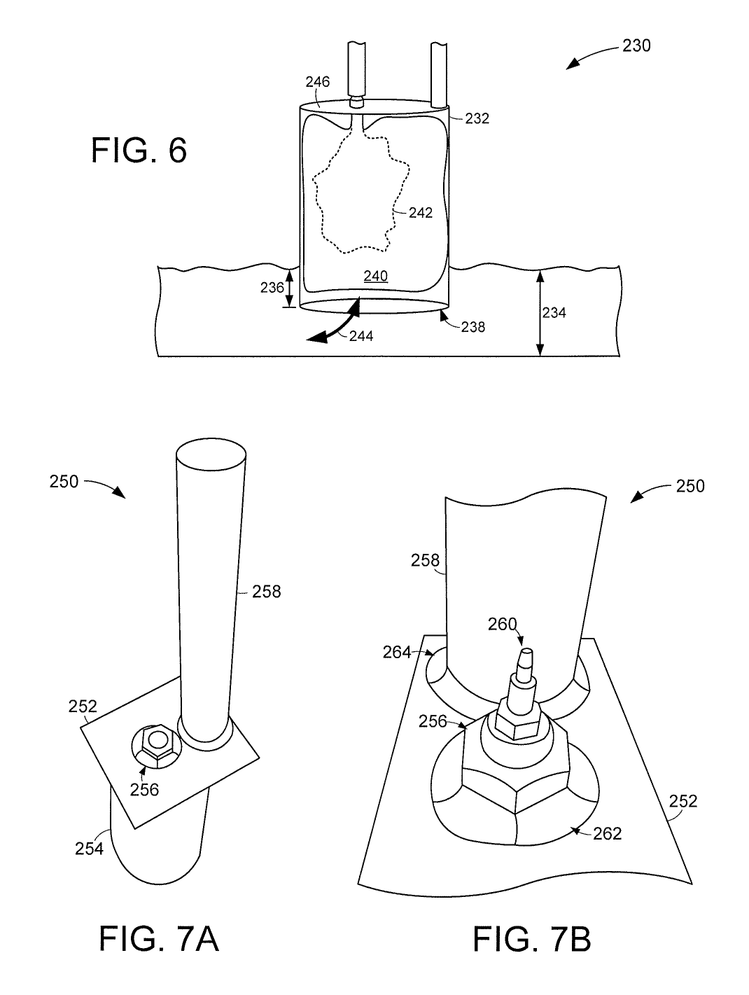

By drawing fluid into the housing 204 through bladder 216 manipulation, accurate measurement can be achieved in as little as an inch of fluid submersion by the housing 204. FIG. 6 illustrates a block representation of an example fluid weight detection tool 230 operated in a surface measuring environment in accordance with some embodiments. As shown, positioning the housing 232 in a predetermined depth 234 of fluid so that the fluid covers a predetermined length 236 of the housing sidewall, such as 1 inch or more, allows the housing inlet/outlet 238 to drawn in and expel fluid from the interior of the housing 232. Through inflated 240 and deflated 242 pneumatic bladder operation, fluid can flow 244 into the housing and exert pressure on the bladder against the interior surfaces of the housing.

With the ability to create differential pressure with the pneumatic bladder and receive immediate feedback through the pneumatic line 246, insertion of the housing 232 into a submerged environment is not mandatory as static and dynamic fluids can be continually measured via a surface mounted housing setup. Obtaining an accurate measurement in as little as an inch of fluid may further allow for testing of small batches of drilling fluid prior to insertion into the wellbore, which contrasts the retroactive measurements of drilling fluid after insertion into the wellbore that can correspond with delayed measurements and contaminated fluid samples. Hence, the ability to proactively test drilling fluid can further allow adjustments to be made to the fluid chemistry, such as increased or reduced weight, to accommodate a wide diversity of wellbore drilling environments.

It can be appreciated from the submerged operation of FIG. 5 and the surface operation of FIG. 6, the tuned configuration of the pneumatic bladder and housing can provide broad fluid measurement capabilities. FIGS. 7A and 7B respectively provide perspective views of portions of an example fluid weight detection tool 250 constructed in accordance with assorted embodiments to be capable of operation in both partially and completely submerged fluid environments. The partial perspective view of FIG. 7A displays how a substantially planar plate 252 can be used to provide the sealed end of an enclosure 254 that houses a pneumatic bladder. Such plate and enclosure construction illustrates how the tool 250 can be an assembly of similar and dissimilar materials and shapes. For example, the enclosure 254 can be a stainless steel to prevent rusting as a result of contact with harsh drilling fluids while the plate 252 is a carbon steel that has a substantially rectangular shape and unfinished texture.

Regardless of the materials and shapes of the enclosure 254 and plate 252, at least one pneumatic receptacle 256 can extend through the plate 252 to access the cavity within the enclosure 254. In the non-limiting embodiment of FIG. 7A, a hollow, threaded nut is welded to the plate 252 to partially close an aperture in the plate 252. Meanwhile, a rigid handle 258 is also welded to the plate 252 to allow articulation of the enclosure 254 without touching the plate 252 or enclosure 254 directly. It should be noted that while the coupling 256 and handle 258 are welded to the plate 252, such construction is not required or limited as any manner of fastening two objects together can be used, such as epoxy, nut and bolt, and magnetics.

Turning to the perspective block representation of the tool 250 shown in FIG. 7B, the pneumatic coupling 256 is engaged by a pneumatic nipple 260 that can be connected to one or more pneumatic lines to control the bladder housed in the enclosure 254. In other words, the pneumatic nipple 260 can seal the aperture in the plate 252 and provide exclusive access to one or more bladders positioned within the enclosure 254. Various embodiments utilize a threaded pneumatic nipple 260 that allows for efficient removal and installation of a different item, such as a multi-port nipple. FIG. 7B further illustrates coupling 262 and handle 264 welds that secure the respective parts to the plate 252. It is to be understood that the welds 262 and 264 can be constructed with strict criteria, such as a full penetration weld, in assorted embodiments to ensure the enclosure 254 remains sealed in view of a wide range of drilling fluid conditions and bladder inflation pressures.

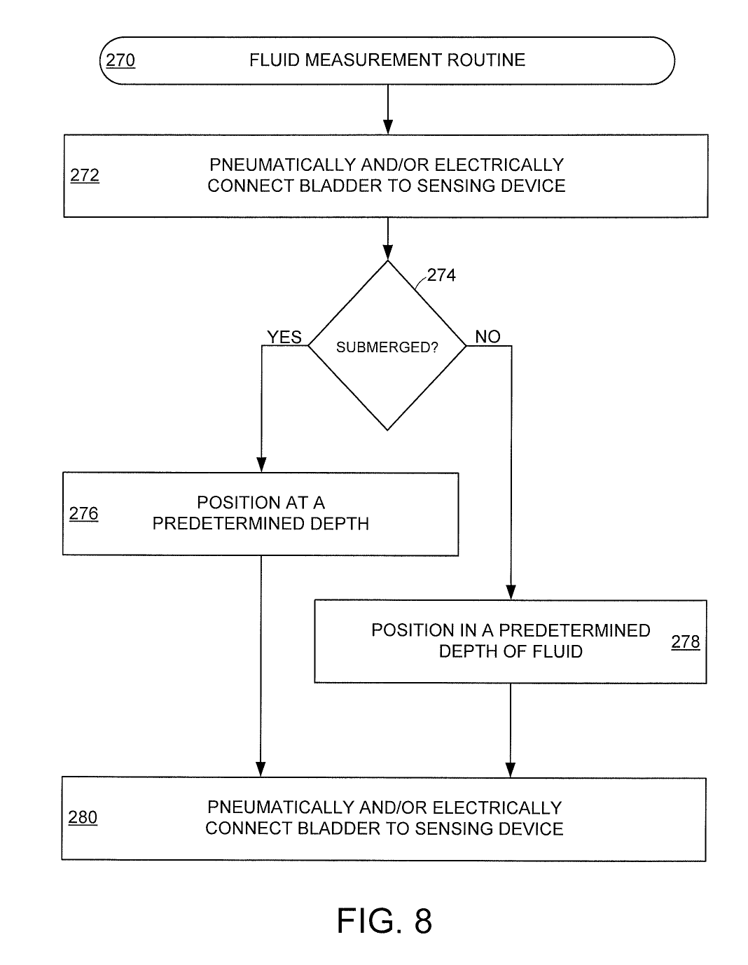

FIG. 8 provides an example fluid measurement routine 270 conducted in accordance with various embodiments. Initially, the routine 270 can pneumatically connect a bladder contained within a shaped housing to an external sensing device in step 272. A determination of where fluid measurements are to be taken is evaluated and decided in decision 274. A choice to conduct submerged fluid measurements proceeds to step 276 where the housing and pneumatic bladder are positioned at a predetermined depth within the submerged environment, possibly through extension of a housing rod, fixed mounting, and floating. Such housing positioning possibilities can allow fluid measurement that is continually, routinely, and sporadically conducted at one or more different submerged depths.

Various embodiments may conduct fluid measurements at submerged depth in conjunction with surface fluid measurements either concurrently or successively. Regardless of the submerged measurement of fluid parameters, a surface fluid measurement determination from decision 274 advances routine 270 to step 278 where the housing and bladder are submerged in a predetermined depth of fluid, such as two inches. The surface fluid measurement may be conducted while the fluid is static and dynamic as step 280 evaluates the pneumatic feedback from the bladder to output a fluid parameter reading, such as fluid weight. Similarly, fluid may be stationary or moving for the bladder and housing to respond to fluid conditions and sense fluid parameters after step 276.

Through routine 270, one or more fluid parameters can be evaluated in real-time and transmitted over a network to multiple different remote nodes. The ability to manipulate the bladder pneumatically creates differential pressure and respond to force exerted by the fluid within the housing, which can be sensed as fluid weight in some embodiments. However, the decision and steps of routine 200 are not required or limited as various elements can be moved, edited, and omitted, as desired. For instance, additional steps of transmitting fluid measurements over a network and tuning the shape of the bladder and housing may be included into routine 270 without limitation.

With a fluid weight detection tool configured and operated in accordance with the various embodiments provided above, harsh drilling fluid can be accurately measured in real-time merely with pressurized air controlling a bladder. The ability to precisely measure at least fluid weight in a variety of partially and completely submerged tool locations allows diverse fluid monitoring that can optimize drilling operations by increasing knowledge about the wellbore geological formations, types of fluids being extracted during drilling, and the quality of fluids like drilling mud that are used to remove debris from the wellbore and in some situations cement wellbore casing.

What is claimed is:

1. An apparatus comprising:
a pneumatic bladder positioned within an enclosure and contacting a fluid; and
a sensing device connected to the pneumatic bladder to measure a weight of the fluid.

2. The apparatus of claim 1, wherein the fluid comprises drilling mud.

3. The apparatus of claim 1, wherein the enclosure comprises a cylinder attached to a plate with a first end of the cylinder being sealed and a second end of the cylinder is open to receive the fluid.

4. The apparatus of claim 3, wherein a pneumatic coupling extends through the plate at the first end of the cylinder.

5. The apparatus of claim 3, wherein a rigid handle is attached to the plate.

6. The apparatus of claim 1, wherein the sensing device comprises a processor and a memory that stores data from the pneumatic bladder.

7. The apparatus of claim 1, wherein the sensing device is connected to a remote node via a network.

8. The apparatus of claim 1, wherein the fluid contacts less than an entirety of the enclosure.

9. A system comprising:
a pneumatic bladder positioned within an enclosure and contacting a fluid, the pneumatic bladder connected to an air tank as part of a sealed measurement string; and
a sensing device connected to the pneumatic bladder to measure a weight of the fluid.

10. The system of claim 9, wherein a pump is connected between the pneumatic bladder and the air tank.

11. The system of claim 9, wherein at least one sensor detects a pressure differential between the pneumatic bladder and air tank.

12. The system of claim 9, wherein the sealed measurement string extends from a wellbore to a ground surface.

13. A method comprising:
positioning a pneumatic bladder within an enclosure;
contacting the pneumatic bladder with a fluid; and
measuring a physical weight of the fluid with a sensing device connected to the pneumatic bladder.

14. The method of claim 13, wherein the pneumatic bladder is inflated and deflated to measure the physical weight.

15. The method of claim 13, wherein the fluid moves during the measuring step.

16. The method of claim 13, wherein the sensing device computes the physical weight in real-time.

17. The method of claim 13, wherein the fluid is drawn into the enclosure by the sensing device deflating the pneumatic bladder.

18. The method of claim 13, wherein the fluid is measured while the enclosure and pneumatic bladder are completely submerged in the fluid.

19. The method of claim 13, wherein the fluid is measured while no more than an inch of the enclosure is submerged in the fluid.

20. The method of claim 13, wherein the sensing device creates differential pressure by inflating and deflating the pneumatic bladder via at least one pump.
